(19) United States
(12) Patent Application Publication
(10) Pub. No.: US 2003/0061488 A1
(43) Pub. Date: Mar. 27, 2003

(54) Cloning protection for electronic equipment

(76) Inventors: Michael Huebler, San Diego, CA (US); Saju Palayur, San Diego, CA (US); Dirk Stockhusen, San Diego, CA (US)

Correspondence Address: Siemens Corporation, Attn: Elsa Keller, Legal Administrator, Intellectual Property Department, 186 Wood Avenue South, Iselin, NJ, 08830, US

(21) Appl. No.: 09/965,279

(22) Filed: Sep. 25, 2001

(51) Int. Cl. H04L 9/00

(52) U.S. Cl. 713/176

(57) ABSTRACT

A method and apparatus for protecting electronic devices from cloning employs an electronic signature generated from an identification code for the electronic device (e.g., an electronic serial number (ESN), an international mobile equipment identifier (IMEI), or the like) and a unique, unchangeable identification for a hardware component of the electronic device code (e.g., a flash hardware serial number, or the like). The electronic signature is encrypted and stored to the non-volatile memory of the electronic device for verifying the authenticity of the electronic device's identification code to prevent use of the device for cloning a second electronic device.

### BACKGROUND OF THE INVENTION

The present invention relates generally to electronic equipment, in particular, mobile communication devices such as mobile telephones and the like used in a mobile communication system. More specifically the present invention relates to a method and apparatus for protecting an electronic device such as a mobile telephone or the like from cloning.

Fraudulent cloning of electronic equipment by copying software components from one device to another is extremely difficult to detect and prevent. For example, cloning of cellular mobile telephones has proven to be a costly problem for both providers of cellular telephone service and their subscribers. A cloned mobile telephone is one that has been reprogrammed to transmit the electronic serial number (ESN), or alternately, the international mobile equipment identifier (IMEI), and phone number (MIN) belonging to another (legitimate) mobile telephone. These codes may be obtained by illegally monitoring the transmissions from the mobile telephones of legitimate subscribers. Each mobile telephone is supposed to have a unique manufacturer programmed electronic serial number. However, after cloning, two or more telephones share a common code. Thus, the communication systems in which the telephones are used often cannot distinguish the cloned mobile telephone from the legitimate one. A cloned mobile telephone can then be used to make calls that will be billed to the subscriber of the legitimate cellular telephone.

To combat fraudulent cloning, many cellular communication networks use an authentication scheme to validate the identity of mobile telephones in the network each time a call is made. However, such authentication techniques often do not adequately protect against cloning wherein all or large portions of the data stored by the mobile telephone's memory are copied. Other techniques for preventing cloning involve encrypting the electronic serial number prior to its storage in the telephone's memory. The electronic serial number is then decrypted prior to transmission. Since encryption is performed by the manufacturer, the electronic serial number is made more difficult to copy or modify. Nevertheless, it is still possible to copy or modify the electronic serial number by first determining the encryption algorithm used.

Consequently, it is desirable to provide a more effective means for protecting electronic devices, in particular, mobile communication devices such as cellular mobile telephones, and the like against cloning.

### SUMMARY OF THE INVENTION

Accordingly, the present invention is directed to a method and apparatus for protecting electronic devices including mobile communication devices such as mobile telephones and the like utilized in wireless communication systems, from cloning.

According to a specific embodiment, the present invention provides a method for preventing cloning of an electronic device. The method includes steps of generating a first electronic signature from a first identification code and a second identification code, where the second identification code is suitable for uniquely identifying a hardware component of the electronic device, and decrypting an encrypted electronic signature for generating a second electronic signature. The method also includes steps of comparing the first electronic signature and the second electronic signature, and departing from normal operation of the electronic device if the first electronic signature and the second electronic signature differ.

According to another specific embodiment, the present invention provides a method for preventing a first non-volatile memory of a first electronic device from being cloned to a second non-volatile memory of a second electronic device. The method includes steps of retrieving a first identification code from the first electronic device, the first identification code uniquely identifying a hardware component of the first electronic device; and assigning a second identification code for the first electronic device, the second identification code uniquely identifying the first electronic device. The method also includes steps of generating an electronic signature from the first identification code and the second identification code; encrypting the electronic signature; and storing the encrypted electronic signature and the second identification code to the first non-volatile memory. The encrypted electronic signature and the second identification code are used for departing from normal operation of the second electronic device if the second non-volatile memory is cloned from the first non-volatile memory.

According to another specific embodiment, the present invention provides an electronic device. The device includes a non-volatile memory; and a controller for controlling operation of the electronic device. The controller is suitable for generating a first electronic signature from a first identification code and a second identification code. The first identification code is suitable for uniquely identifying a hardware component of the electronic device, decrypting an encrypted electronic signature for generating a second electronic signature, comparing the first electronic signature and the second electronic signature, and causing the electronic device to depart from normal operation if the first electronic signature and the second electronic signature differ.

It is to be understood that both the foregoing general description and the following detailed description are exemplary and explanatory only and are not restrictive of the invention claimed. The accompanying drawings, which are incorporated in and constitute a part of the specification, illustrate specific embodiments of the invention and together with the general description, serve to explain the principles of the invention.

### BRIEF DESCRIPTION OF THE DRAWINGS

The numerous objects and advantages of the present invention may be better understood by those skilled in the art by reference to the accompanying figures in which:

FIG. 1 is a block diagram illustrating the generation of an encrypted electronic signature for securing an electronic device against cloning in accordance with an exemplary embodiment of the present invention;

FIG. 2 is a flow diagram illustrating a method for generating and storing an electronic signature within the non-volatile memory of an electronic device in accordance with an exemplary embodiment of the present invention;

FIG. 3 is a block diagram illustrating an exemplary non-volatile memory (e.g., a flash memory, or the like) of an electronic device having an encrypted electronic signature stored therein in accordance with the present invention;

FIG. 4 is a block diagram illustrating use of the electronic signature for preventing cloning of an electronic device by verifying the authenticity of the electronic device's identification code, thereby preventing the identification code from being changed by unauthorized parties;

FIG. 5 is a diagram illustrating a manufacturing process for generating and storing an encrypted electronic signature within the non-volatile memory of an electric device in accordance with the present invention; and

FIG. 6 is a block diagram illustrating an exemplary electronic device, in particular a mobile telephone, implementing the present invention.

### DETAILED DESCRIPTION OF THE INVENTION

The present invention provides a method and apparatus for protecting electronic devices including mobile communication devices, such as mobile telephones and the like utilized in wireless communication systems, from cloning. Each electronic device is provided with an identification code such as an electronic serial number (ESN) or the like that is stored within non-volatile memory and thereafter used to identify the device to external sources. If the electronic device is later used as a clone of another electronic device, this identification code is changed to the identification code of the device being cloned so that the electronic device may thereafter identify itself to external sources as the cloned device. The present invention generates a unique electronic signature for the electronic device using the identification code for the electronic device and a second identification code uniquely identifying a hardware component of the device (e.g., a flash hardware serial number, a processor hardware serial number, or the like). The electronic signature is then encrypted and stored to the device's non-volatile memory for verifying the authenticity of the identification code, thereby preventing the identification code from being changed by unauthorized parties. In this manner, the electronic device may not be used to clone a second device. Aspects and detailed features of the invention are further described below.

In a first aspect of the invention, an electronic signature for securing an electronic device against cloning is generated, encrypted and stored to a non-volatile memory of the electronic device. The electronic signature is calculated from an identification code for the electronic device (e.g., an electronic serial number (ESN), an international mobile equipment identifier (IMEI), or the like) and a unique, unchangeable identification code (e.g., a flash hardware serial number, a processor hardware serial number, a combination of resistor values, or the like) for a hardware component of the electronic device using a hash function, or the like. The electronic signature is then encrypted using a suitable encryption algorithm and stored to the non-volatile memory of the electronic device for verifying the authenticity of the electronic device's identification code.

In a second aspect of the invention, the electronic signature, stored in the non-volatile memory of the electronic device, is used to verify the authenticity of the electronic device identification code in order to detect use of the device to clone a second electronic device. In exemplary embodiments, the encrypted electronic signature, the electronic device's identification code, the identification code identifying a hardware component of the electronic device, and optionally a decryption key for decryption of the encrypted electronic signature are retrieved from the non-volatile memory of the electronic device. A first electronic signature is then calculated from the identification code for the electronic device and the identification code for a hardware component of the electronic device. The earlier stored encrypted electronic signature is decrypted (e.g., using the decryption key) for generating a second electronic signature. The first electronic signature and the second electronic signature are then compared. If the electronic signatures are identical, the electronic device's identification code is determined to be authentic and the device is allowed to operate normally. If, however, the first electronic signature and second electronic signature differ, the electronic device's identification code is determined to not be authentic and operation of the electronic device may be interrupted. In this manner, the use of the electronic device for cloning a second electronic device is prevented.

Reference will now be made in detail to the presently preferred embodiments of the invention, examples of which are illustrated in the accompanying drawings.

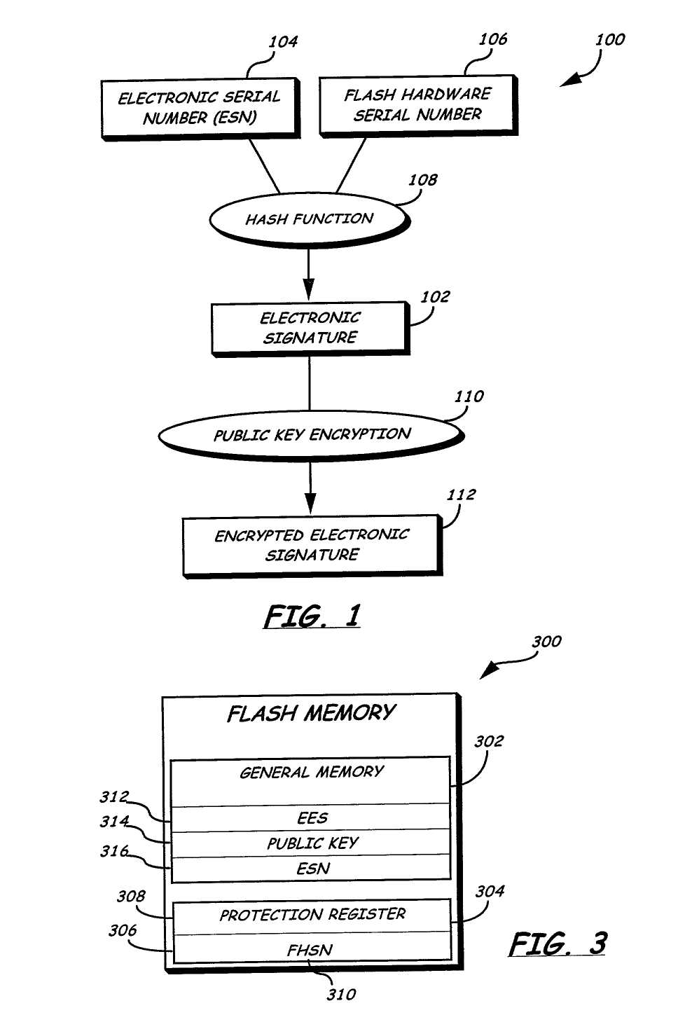

FIG. 1 illustrates the generation of an encrypted electronic signature for securing an electronic device against cloning in accordance with an exemplary embodiment of the present invention 100. An electronic signature 102 is calculated from an identification code for the electronic device 104 and a unique identification code for a hardware component of the electronic device 106 using a hash function 108, or the like. The electronic signature 102 is next encrypted, using a suitable encryption algorithm 110, to provide an encrypted electronic signature 112 that may be stored to the non-volatile memory of the electronic device for verifying the authenticity of the electronic device identification code 104.

The identification code for the electronic device 104 may comprise any number or value suitable for uniquely identifying the electronic device to external sources. Thus, identification code 104 may comprise an electronic serial number (ESN), an international mobile equipment identifier (IMEI), an A-key number, a service operator code (SOC), a part number or serial number for the electronic device, or the like, or, alternately, combinations of such codes. For example, in the embodiment shown in FIG. 1, identification code 104 is illustrated as being an electronic serial number (ESN). Electronic serial numbers are commonly used to identify communication devices such as mobile telephones, or the like, within a wireless communication system for purposes of call placement, billing, and the like. The electronic serial number is a unique, unchangeable 32-bit binary provided by the manufacturer of the device for identifying the device to the wireless network in which it is used. The electronic serial number together with a mobile identification number (MIN), a unique 24-bit number assigned by the wireless service provider, are automatically transmitted to the wireless network each time the phone is used to verify that it has not been reported lost or stolen and that all subscriber bills are current.

The identification code for a hardware component of the electronic device 106 may likewise comprise any number or value suitable for uniquely identifying a hardware component of the electronic device. Preferably, this identification code is permanently programmed to a non-volatile memory so that it cannot be altered by unauthorized parties (e.g., a person wishing to use the electronic device to clone another device). For example, in exemplary embodiments, such as the embodiment shown in FIG. 1, the non-volatile memory employed by the electronic device may comprise a flash memory. In such embodiments, identification code 106 may be comprised of a flash hardware serial number, consisting of a unique, unchangeable 64-bit binary value that is permanently programmed to a one-time programmable (OTP) protection register of the flash memory by the memory manufacturer. The one-time programmable protection register is a 128-bit non-volatile storage space integrated into the flash memory that is stored separately from the main memory array of the flash memory. The one-time programmable protection register may be divided into two 64-bit segments, with one 64-bit segment containing the flash hardware serial number programmed during device manufacturing, and a second 64-bit customer segment being left blank for a customer (e.g., the electronic device manufacturer) to program as desired. Once the customer segment is programmed, it, like the flash hardware serial number, can be permanently locked to prevent change by unauthorized parties.

In exemplary embodiments of the invention, electronic signature 102 is generated from identification code 104 and identification code 106 using a suitable hash function 108 such as an MD4 or MD5 hash function, a SHA-1 hash function (which produces a 160-bit output), or the like. Such hash functions comprise transformations that take an input of any length and returns a fixed-length output according to the equation

h=H(m)

where H represents the hash function, m represents the input (identification codes 104 and 106), and h represents the output (electronic signature 102).

The length of the electronic signature 102 generated depends on the hash function selected. For example, the MD4 and MD5 hash functions each produce 128 bit outputs while the SHA-1 hash function produces a 160-bit output. Thus, an electronic signature calculated using the MD4 or MD5 hash functions will have a length of 128 bits, while an electronic signature calculated using a SHA-1 hash function will have a length of 160 bits. It will be appreciated that other hash function may also be used, resulting in electronic signatures having different lengths.

Preferably, the hash function used by the present invention is one-way and collision free. A hash function H is said to be one-way if it is hard to invert, where “hard to invert” means that given a hash value h, it is computationally infeasible to find some input x such that H(x)=h. If, given an input x, it is computationally infeasible to find an input y not equal to x such that H(x)=H(y), then H is said to be a weakly collision-free hash function. A strongly collision-free hash function H is one for which it is computationally infeasible to find any two messages x and y such that H(x)=H(y).

As shown in FIG. 1, the electronic signature 102 may be encrypted using a public key encryption algorithm 110. For instance, in exemplary embodiments, a “c=m^{e} mod n” public key encryption algorithm may be used to encrypt the electronic signature 102. The “c=m^{e} mod n” public key encryption algorithm is described in U.S. Pat. No. 4,405,829, entitled “Cryptographic Communications System And Method” issued to the Massachusetts Institute of Technology (MIT) on Sep. 20, 1983. However, it will be appreciated by those of skill in the art that the electronic signature 102 may be encrypted using other encryption techniques without departing from the scope and spirit of the invention.

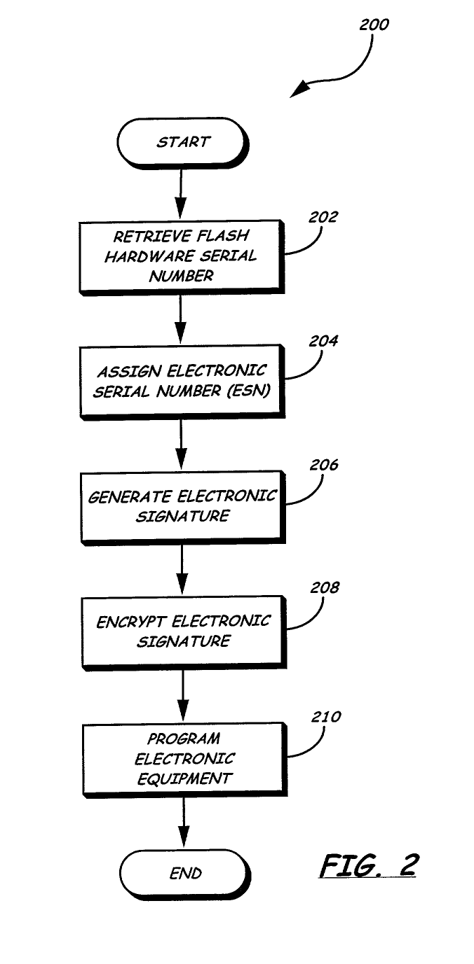

Referring now to FIG. 2, a method 200 for generating and storing an electronic signature within an electronic device is described. In the exemplary embodiment shown, an identification code for uniquely identifying a hardware component of the electronic device is retrieved from the non-volatile memory at step 202. For instance, wherein the electronic device employs a flash memory, the flash hardware serial number is retrieved from the one time programmable protection register of the flash memory. A second identification code suitable for identifying electronic device is then assigned at step 204. For example, in embodiments of the invention where the electronic device comprises a mobile communication device, the device's manufacturer may assign an electronic serial number (ESN), international mobile equipment identifier (IMEI), or the like to the device. An electronic signature is then generated, at step 206, from the identification codes acquired at steps 202 and 204 using a suitable hash function such as an MD5 hash function, a SHA-1 hash function, or the like. This electronic signature may next be encrypted, at step 208, using a public key encryption algorithm such as the “c=m^{e} mod n” public key encryption algorithm discussed in the description of FIG. 1. The electronic device is then programmed with the encrypted electronic signature, at step 210, by storing the encrypted electronic signature and the identification code for the electronic device (e.g., the electronic serial number (ESN) for the device) to the non-volatile memory. In embodiments of the invention, a decryption key may be created during encryption of the electronic signature and stored to the non-volatile memory to allow decryption of the electronic signature by the electronic device. For instance, where the electronic signature is encrypted using a public key encryption algorithm, a public key is generated to allow decryption of the electronic signature. This public key may be stored to the non-volatile memory along with the encrypted electronic signature and electronic device identification code, at step 210.

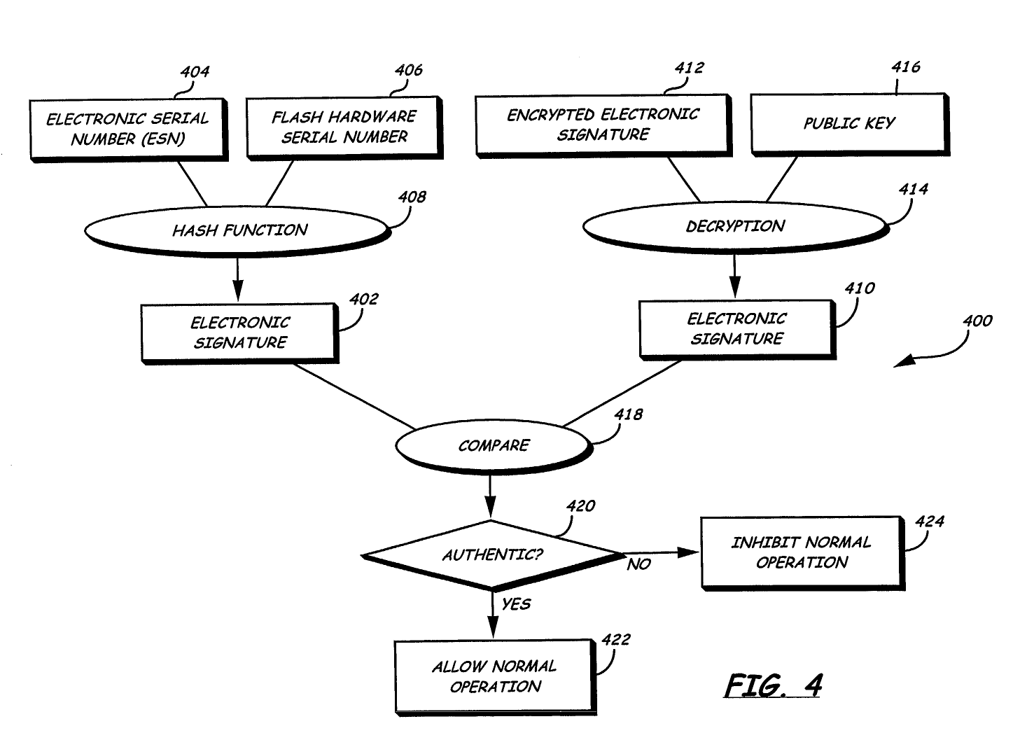

FIG. 3 illustrates storage of the encrypted electronic signature, identification code (e.g., electronic serial number (ESN) or the like), and a decryption key by an exemplary non-volatile memory in accordance with the present invention. In the embodiment shown, the non-volatile memory employed by the electronic device is comprised of a flash memory 300. The flash memory 300 includes a main memory array 302 and a one time programmable (OTP) protection register 304. As discussed in the description of FIG. 1, the one-time programmable protection register 304 may comprise a 128-bit non-volatile storage space integrated into the flash memory 300 separately from the main memory array 302. This 128-bit storage space is divided into two 64-bit segments 306 and 308, with one 64-bit segment 306, containing the flash hardware serial number 310 programmed during manufacture of the memory, and a second 64-bit segment 308 being left blank for a customer (e.g., the electronic device manufacturer) to program as desired. Preferably, once either segment 306, 308 of the protection register 304 is programed that segment 306, 308 can be permanently locked to prevent alteration of the contents stored therein (specifically the flash hardware serial number) by unauthorized parties.

As shown in FIG. 3, an encrypted electronic signature 312 in accordance with the present invention may be stored within the one or more blocks of the general memory array 302 along with a decryption key (e.g., a public key) 314 used for decrypting the electronic signature, and an identification code (e.g., an electronic serial number) 316 for the electronic device in which the memory is used. It is noted that the identification code for the electronic device 316 need not be encrypted prior to storage, and thus, need not be decrypted each time it is used for identification of the electronic device. For example, where the electronic device comprises a mobile communication device and the identification code 316 comprises an electronic serial number (ESN), an international mobile equipment identifier (IMEI) used for identifying the device to the wireless network in which it is used, the code need not be decrypted each time a call is made, freeing resources such as processor time, memory, and the like. Nevertheless, in embodiments of the invention, the identification code 316 may also be encrypted prior to storage in the memory 300 if so required by a particular application.

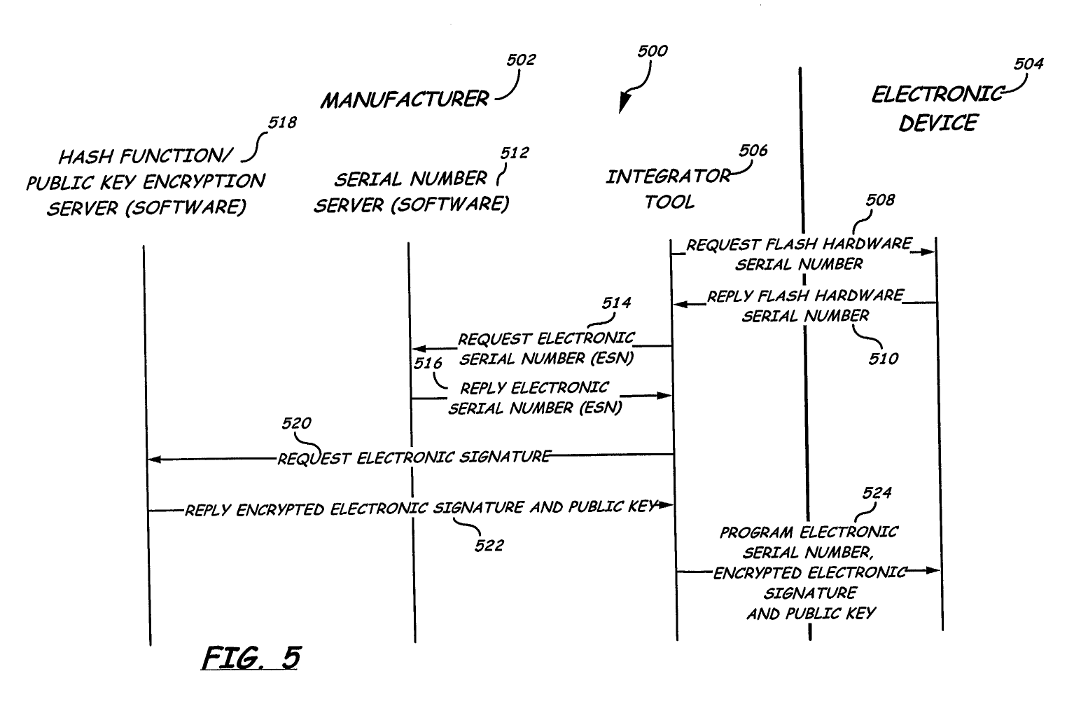

FIG. 4 illustrates a method 400 for using the electronic signature for verifying the authenticity of the electronic device's identification code, thereby preventing the identification code from being changed by unauthorized parties. In exemplary embodiments, the method 400 illustrated in FIG. 4 may be utilized to periodically verify the electronic device's identification code to ensure that the device has not been used to clone a second device. For instance, the method 400 may be initiated each time the electronic device is powered on, in which case, the device may be prevented from providing normal operation if the identification code is not authentic.

As shown in FIG. 4, a first electronic signature 402 is generated from an identification code for the electronic device 404 and a unique identification code for a hardware component of the device 406 using a hash function 408, or the like. For example, in embodiments of the invention wherein the electronic device comprises a mobile communication device having a non-volatile flash memory, the identification code for the electronic device 404 may comprise an electronic serial number (as shown in FIG. 1), or, alternately, an international mobile equipment identifier (IMEI), or the like stored within the device's flash memory. In such embodiments, the identification code for a hardware component of the device 406 may comprise a flash hardware serial number retrieved from the one time programmable protection register of the flash memory. The electronic signature 402 may then be calculated from the electronic serial number and flash hardware serial number using a suitable hash function 408 such as an MD5 hash function, a SHA-1 hash function, or the like.

A second electronic signature 410 is generated by decrypting an encrypted electronic signature 412 stored within the non-volatile memory of the device, as described in the discussion of FIGS. 1 through 3, using a suitable decryption algorithm 414. The decryption algorithm 414 may employ a suitable decryption key 416 for decryption of the encrypted electronic signature 412. For instance, in exemplary embodiments wherein a public key encryption algorithm is used for encrypting the encrypted electronic signature 412, the decryption key 416 may comprise a public key generated during encryption of the encrypted electronic signature 412 and stored to the non-volatile memory with the encrypted electronic signature 412.

The first electronic signature 402 and the second electronic signature 410 are then compared at 418. If the electronic signatures 402 and 410 are found to be identical, the identification code for the electronic device 404 (e.g., a electronic serial number (ESN), international a mobile equipment identifier (IMEI), or the like) is determined to be authentic at 420 and the device is allowed to operate normally at 422. If, however, the first electronic signature 402 and second electronic signature 410 differ, the identification code (e.g., electronic serial number (ESN), international mobile equipment identifier (IMEI), or the like) is determined to not be authentic at 420, in which case, the electronic device may be made to depart from normal operation. In one embodiment, shown in FIG. 4, operation of the electronic device may then be interrupted, at 424, so that the device cannot be used. For example, the electronic device may be shut down or go into a lock out state. Alternately, the electronic device may continue to operate but may provide a warning to the user or network in which the device is used that the electronic device has been used to clone another device.

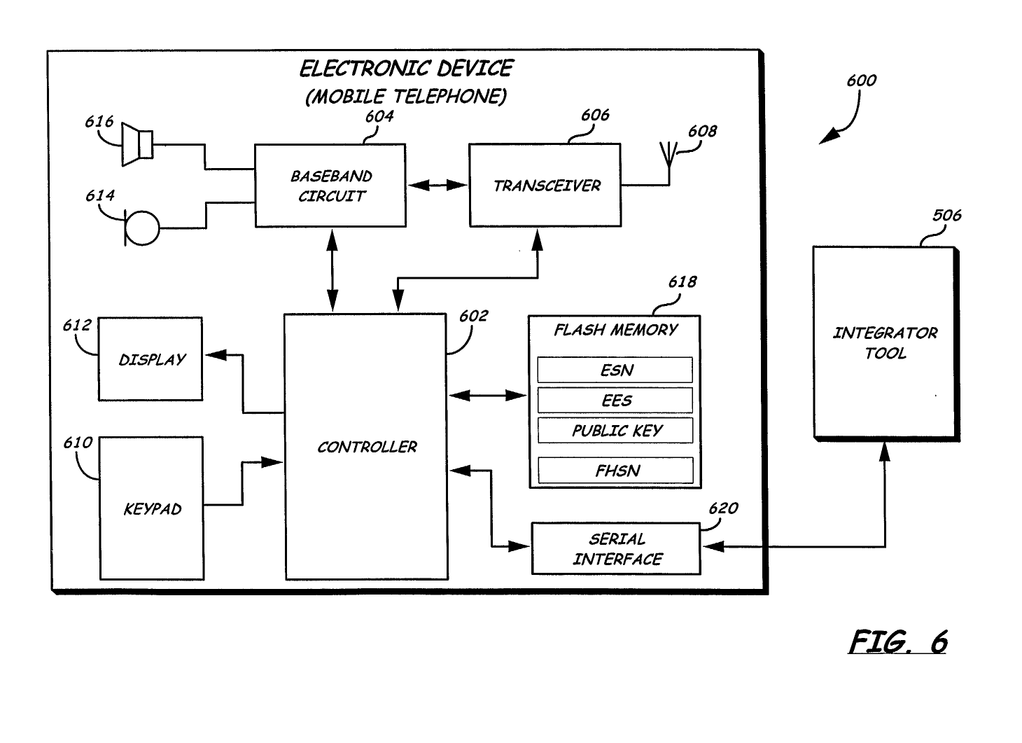

Referring now to FIG. 5, a manufacturing process 500 suitable for use by a manufacturer 502 for generating and storing an encrypted electronic signature within the non-volatile memory of an electric device 504 using the method 200 of FIG. 2 is described. An integrator assembly or tool 506 provides an interface with the electronic device 504 for programming of the device's non-volatile memory, in this case, a non-volatile flash memory. As shown in FIG. 5, the integrator tool 506 first retrieves the flash hardware serial number for the non-volatile flash memory of the electronic device 504 from the flash memory itself. In exemplary embodiments, the integrator tool 506 may issue a request to the electronic device 504 for the flash serial number, at process step 508. The electronic device 504 may then interrogate the flash memory and retrieve the flash hardware serial number from the memory's protection register whereupon it is provided to the integrator tool 506, at process step 510.

The integrator tool then retrieves an identification code, in this case an electronic serial number (ESN), for the electronic device. For instance, as shown in FIG. 5, the integrator tool 506 may provide a request for assignment of an electronic serial number to a serial number server 512, at process step 514. In exemplary embodiments, the serial number server 512 controls assignment of electronic serial numbers by the manufacturer so that each electronic device 504 produced has an electronic serial number that is unique to that device (i.e., is not duplicated by another electronic device produced by that or any other manufacturer). The serial number server then assigns an electronic serial number to the electronic device 504 and provides this number to the integrator tool, at process step 516.

An encrypted electronic signature is then generated from the electronic serial number and flash hardware serial number. As shown in FIG. 5, the integrator tool provides a request to the hash function/public key encryption server 518, at process step 520. The hash function/public key encryption server 518 generates an electronic signature for the electronic device 504 using a suitable hash function such as an MD5 hash function, a SHA-1 hash function, or the like, and then encrypts the electronic signature using a public key encryption algorithm such as the “c=m^{e} mod n” public key encryption algorithm discussed in the description of FIG. 1. The hash function/public key encryption server 518 then provides the encrypted electronic serial number, along with a public key for its decryption to the integrator tool 506, at process step 522. The integrator tool 506 next programs the electronic device 504 with the encrypted electronic signature, public key, and electronic serial number, at process step 524, storing the encrypted electronic signature for the electronic serial number assigned to the device to its non-volatile flash memory.

FIG. 6 illustrates an exemplary electronic device 600 implementing the present invention. The electronic device 600 is characteristic of a mobile telephone or like mobile communication device suitable for use in a wireless communication network. The electronic device 600 includes a controller or processor 602 for controlling the overall operation of the device. The electronic device 600 further includes a baseband circuit 604, a transceiver 606, and an antenna 608 for communication of voice and data information via a radio frequency communication link with a wireless communication network (e.g., via a base station within a cellular communication network). The electronic device 600 may further include a keypad 610 suitable for entry of information such as telephone numbers, commands, and the like by a user, a display 612 suitable for displaying information to the user, and a microphone 614 and speaker 616 suitable for telephonic voice communication, entry of voice commands, and the like.

As shown in FIG. 6, the controller 602 is coupled to a non-volatile memory 618 such as a flash memory (e.g., flash memory 300 illustrated in FIG. 3), an electrically erasable programmable read-only memory (EEPROM), or the like, via a bus circuit or like interconnection means. An interface 620, such as a serial interface or other interface, allows exchange of information between the controller and an external device, such as the integrator tool 506 (see FIG. 5) used to program the non-volatile memory 618 for storage of the encrypted electronic signature (“EES”), identification code for the electronic device (e.g., an electronic serial number (“ESN”)), and a decryption key (“Public Key”) in accordance with the present invention.

In exemplary embodiments of the invention, the controller 602 may periodically verify the authenticity of the electronic device's identification code using the encrypted electronic signature, identification code for the electronic device (e.g., the electronic serial number), an identification code identifying an electronic component of the electronic device 600 (e.g., a flash hardware serial number (“FHSN”)), and the decryption key stored in the non-volatile memory 618. For instance, the controller 602 may implement the method 400 illustrated in FIG. 4 each time the electronic device 600 is powered on to verify the electronic device's identification code for ensuring that the device has not been used to clone a second device.

Although the invention has been described with a certain degree of particularity, it should be recognized that elements thereof may be altered by persons skilled in the art without departing from the scope and spirit of the invention. It is understood that the specific orders or hierarchies of steps in the methods described herein, are examples of exemplary approaches. Based upon design preferences, it is understood that the specific orders or hierarchies of these methods can be rearranged while remaining within the scope of the present invention. The accompanying method claims present elements of the various steps of the methods described herein in a sample order, and are not meant to be limited to the specific order or hierarchy presented.

It is believed that the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method for preventing cloning of an electronic device, said method comprising steps of:
generating a first electronic signature from a first identification code and a second identification code, the second identification code being suitable for uniquely identifying a hardware component of the electronic device;
decrypting an encrypted electronic signature for generating a second electronic signature;
comparing the first electronic signature and the second electronic signature; and
departing from normal operation of the electronic device if the first electronic signature and the second electronic signature differ.

2. The method as claimed in claim 1, further comprising retrieving the encrypted electronic signature, the first identification code and the second identification code from a non-volatile memory.

3. The method as claimed in claim 1, wherein generating the first electronic signature comprises using a hash function for computing the first electronic signature from the first identification code and the second identification code.

4. The method as claimed in claim 3, wherein the hash function comprises an MD5 algorithm.

5. The method as claimed in claim 1, wherein decrypting the encrypted electronic signature further comprises using a decryption key.

6. The method as claimed in claim 4, wherein the encrypted electronic signature is encrypted using a public key encryption algorithm and the decryption key comprises a public key.

7. The method as claimed in claim 6, wherein the public key encryption algorithm comprises a “c=m^{e} mod n” public key encryption algorithm.

8. The method as claimed in claim 1, wherein the first identification code comprises an electronic serial number (ESN).

9. The method as claimed in claim 1, wherein the hardware component comprises a non-volatile memory of the electronic device and the second identification code comprises an identification code suitable for uniquely identifying the non-volatile memory.

10. The method as claimed in claim 1, wherein the hardware component comprises a non-volatile flash memory, and the second identification code comprises a flash hardware serial number permanently stored in the flash memory.

11. The method as claimed in claim 1, wherein the hardware component comprises a processor of the electronic device and the second identification code comprises an identification code suitable for uniquely identifying the processor.

12. The method as claimed in claim 1, wherein departing from normal operation of the electronic device comprises inhibiting normal use of the electronic device.

13. The method as claimed in claim 1, wherein departing from normal operation of the electronic device comprises allowing normal use of the electronic device while providing a warning to at least one of a user of the electronic device and a network in which the device is used that the electronic device has been used to clone a second electronic device.

14. A method for preventing a first non-volatile memory of a first electronic device from being cloned to a second non-volatile memory of a second electronic device, the method comprising steps of:
retrieving a first identification code from the first electronic device, the first identification code for uniquely identifying a hardware component of the first electronic device;
assigning a second identification code for the first electronic device, the second identification code for uniquely identifying the first electronic device;
generating an electronic signature from the first identification code and the second identification code;
encrypting the electronic signature; and
storing the encrypted electronic signature and the second identification code to the first non-volatile memory, the encrypted electronic signature and the second identification code being used for departing from normal operation of the second electronic device if the second non-volatile memory is cloned from the first non-volatile memory.

15. The method as claimed in claim 14, wherein generating the electronic signature comprises using a hash function for computing the electronic signature from the first identification code and the second identification code.

16. The method as claimed in claim 15, wherein the hash function comprises an MD5 algorithm.

17. The method as claimed in claim 14, further comprising storing a decryption key to the first non-volatile memory for decrypting the encrypted electronic signature.

18. The method as claimed in claim 17, wherein the encrypted electronic signature is encrypted using a public key encryption algorithm and the decryption key comprises a public key.

19. The method as claimed in claim 18, wherein the public key encryption algorithm comprises a “c=m^{e} mod n” public key encryption algorithm.

20. The method as claimed in claim 14, further comprising:
retrieving a third identification code from the second non-volatile memory, the third identification code for uniquely identifying the second non-volatile memory;
generating a second electronic signature from the second identification code and the third identification code;
retrieving the encrypted electronic signature from the second non-volatile memory;
decrypting the encrypted electronic signature for generating a third electronic signature;
comparing the second electronic signature and the third electronic signature; and
thereafter departing from normal operation of the second electronic device if the second electronic signature and the third electronic signature differ.

21. The method as claimed in claim 20, wherein generating the second electronic signature comprises using a hash function for computing the second electronic signature from the second identification code and the third identification code.

22. The method as claimed in claim 21, wherein the hash function comprises an MD5 algorithm.

23. The method as claimed in claim 14, wherein the first and second non-volatile memories comprise flash memories, and the first and third identification codes comprise flash hardware serial numbers permanently stored in the flash memories.

24. The method as claimed in claim 23, wherein the second identification code comprises an electronic serial number (ESN).

25. An electronic device, comprising:
a non-volatile memory; and
a controller for controlling operation of the electronic device,
wherein the controller is suitable for generating a first electronic signature from a first identification code and a second identification code, the first identification code being suitable for uniquely identifying a hardware component of the electronic device; decrypting an encrypted electronic signature for generating a second electronic signature; comparing the first electronic signature and the second electronic signature, and causing the electronic device to depart from normal operation if the first electronic signature and the second electronic signature differ.

26. The electronic device as claimed in claim 25, wherein the controller retrieves the encrypted electronic signature, the first identification code and the second identification code from at least one of the non-volatile memory and a second non-volatile memory of the electronic device.

27. The electronic device as claimed in claim 25, wherein the controller generates the first electronic signature using a hash function.

28. The electronic device as claimed in claim 27, wherein the hash function comprises an MD5 algorithm.

29. The electronic device as claimed in claim 25, wherein the controller employs a decryption key for decrypting the encrypted electronic signature.

30. The electronic device as claimed in claim 25, wherein the encrypted electronic signature is encrypted using a public key encryption algorithm and the decryption key comprises a public key.

31. The electronic device as claimed in claim 30, wherein the public key encryption algorithm comprises a “c=m^{e} mod n” public key encryption algorithm.

32. The electronic device as claimed in claim 25, wherein the non-volatile memory comprises a flash memory, and the first identification code comprises a flash hardware serial number permanently stored in the flash memory.

33. The electronic device as claimed in claim 25, wherein the second identification code comprises an electronic serial number (ESN).

34. An electronic device, comprising:
means for generating a first electronic signature from a first identification code and a second identification code, the first identification code being suitable for uniquely identifying a hardware component of the electronic device;
means for decrypting an encrypted electronic signature for generating a second electronic signature;
means for comparing the first electronic signature and the second electronic signature, and
means for departing from normal operation of the electronic device if the first electronic signature and the second electronic signature differ.

35. The electronic device as claimed in claim 34, wherein the non-volatile memory comprises a flash memory, and the first identification code comprises a flash hardware serial number permanently stored in the flash memory.

36. The electronic device as claimed in claim 34, wherein the second identification code comprises an electronic serial number (ESN).
